(19) United States
(12) Patent Application Publication
(10) Pub. No.: US 2016/0075126 A1
(43) Pub. Date: Mar. 17, 2016

(54) TANGENTIAL FLEXOGRAPHIC PLATE MOUNTING DEVICE AND MACHINE WITHOUT TENSION

(71) Applicant: Bieffebi S.r.l., Granarolo dell'Emilia (Bologna) (IT)

(72) Inventor: Stefano SAMBRI, San Lazzaro di Savena (Bologna) (IT)

(21) Appl. No.: 14/855,620

(22) Filed: Sep. 16, 2015

(30) Foreign Application Priority Data
Sep. 16, 2014 (IT) BO2014A000510

(51) Int. Cl. B41F 3/54

(52) U.S. Cl. CPC B41F 3/54

(57) ABSTRACT

A tangential flexographic plate mounting device without tension on a flexible support, including a frame and a rigid cylindrical support rotatably coupled with said frame, said cylindrical support including an outer surface on which it is possible to apply at least a flexible support, on which in turn a flexographic plate, complete with double-sided tape, is fixable. The device includes an applicator roller of the plate, complete with double-sided tape, on the flexible support, mobile between an inactive position and an operative application position of said plate complete with double-sided tape on said flexible support from an end edge thereof or from the middle portion thereof, in such operative position and during application the plate being wrapped around at least a portion of the outer cylindrical surface of said application roller, in order to assume, during application, an opposite curvature to that of said cylindrical support.

### CROSS REFERENCE TO RELATED APPLICATIONS

This application claims the benefit of priority from Italian Patent Application No. BO2014A000510 filed on Sep. 16, 2014, the contents of which are incorporated herein by reference.

### TECHNICAL FIELD OF THE INVENTION

The present invention relates to a tangential flexographic plate mounting device and machine without tension.

More in particular, the invention relates to a tangential flexographic plate mounting device and machine without tension on flexible supports.

### PRIOR ART

It is known that flexographic printing plates are mounted on respective cylindrical rigid supports using special mounting machines.

More in detail, these machines allow a flexographic printing plate to be accurately applied, in relation to specific position references, on a sheet of double-sided tape which in turn adheres to the surface of the cylindrical support.

The above cylindrical support may be of different kind in relation to the specific field in which a particular printing job must be carried out.

For example, with reference to the field of flexographic printing on corrugated cardboard, the cylindrical rigid support normally comprises an outer flexible support of Mylar®, or other equivalent yielding or flexible material, wrapped around the cylindrical support itself and onto which the plate is applied, already complete with double-sided tape; after the application of the plate complete with double-sided tape, said flexible support is usually removed from the cylindrical rigid support to be mounted on a specific printing machine for corrugated cardboard.

Irrespective of the type of cylindrical support used, as known one of the major technical problems encountered in the fixing of plates already complete with double-sided tape on the flexible support, is the elimination of any air bubbles present between the components and formed during the mutual coupling of the same.

As is easily understood, such a drawback is more felt when the size of the plate is larger.

Such a phenomenon, if not tackled properly, can cause local deformations in the plate that then inevitably impact on the quality of the printing job.

The phenomenon is also more accentuated when a double-sided tape of poor quality is used, which obviously cannot ensure a perfect and consistent adhesion of the components over time.

To work around the above drawback, mechanical systems have been developed in some types of machines that, after the coupling between the plate, complete with double-sided tape, and the flexible support, compress the surface of the plate itself so that the air bubbles that may be trapped between the components are forced to escape sideways.

However, these mechanical systems have proved in practice to be poorly effective in situations of particularly thick plates—even up to about 7-8 mm—and/or plates with large differences in thickness between high and low relief.

In addition to that, the provision of such systems on the plate mounting machine causes an increase in cost that often the potential buyer does not want to pay.

In fact, some of these systems are operated by actuators, such as pneumatic, which sometimes force to provide the machine with a system exclusively dedicated to their control and actuation.

Another drawback related with the use of such known machines is that the flexible support and the plate, which are coupled one another on a cylindrical surface (the cylindrical rigid support), undergo, after coupling, a permanent deformation which is determined by the curved surface on which they are coupled.

In other words, when the flexible support—together with the plate—is removed from the cylindrical rigid support, for example to be stored or to be mounted on a printing machine, it is not planar, but it keeps the curvature conferred by the rigid support on which it was carried out the assembly, because of the tensions remaining in the coupling between the two components.

In such situation, any attempt to stretch or unfold the flexible support—for example to accommodate it on a cylindrical support of different diameter, or to store it vertically—may inevitably cause detachments between the flexible support and the plate.

During the printing work, the ink can penetrate into these detachments, with the risk of causing damage to both the plate and the machine.

### SUMMARY OF THE INVENTION

The technical task of the present invention therefore is to improve the prior art.

Within this technical task, one object of the present invention is to develop a tangential flexographic plate mounting device without tension that allows coupling the plate complete with double-sided tape on the flexible support without the formation of air bubbles or detachments between the components.

Another object of the present invention is to provide a tangential flexographic plate mounting device without tension which allows the optimal coupling between plate complete with double-sided tape and flexible support to be obtained without the aid of pressure devices for ejecting the air bubbles.

Another object of the present invention is to provide a tangential flexographic plate mounting device without tension which allows achieving a faster and easier assembly of the plate complete with double-sided tape and the flexible support.

Still another object of the present invention is to provide a tangential flexographic plate mounting device without tension which allows obtaining an assembly of the plate complete with double-sided tape and the flexible support free from residual stresses.

Yet another object of the present invention is to provide a tangential flexographic plate mounting machine without tension incorporating the above device.

Such a task and such objects are all achieved by a tangential flexographic plate mounting device without tension according to the present disclosure, and by a tangential flexographic plate mounting machine including such mounting device.

Such a task and such objects are also achieved by a method for fixing a flexographic plate on a flexible support.

The tangential flexographic plate mounting device without tension on a flexible support comprises a frame and a rigid cylindrical support rotatable coupled with the frame; the cylindrical support comprises an outer surface on which it is possible to apply at least a flexible support.

On such flexible support, in turn, a flexographic plate, complete with double-sided tape, is fixable.

According to the invention, the mounting device comprises at least one applicator roller of the plate, complete with double-sided tape, on the flexible support, having an axis of symmetry parallel to that of the cylindrical support.

The applicator roller is mobile between an inactive position and an operative application position of the plate, complete with double-sided tape, on the flexible support from and edge thereof or from the middle portion.

In such operative position the applicator roller is kept in rolling contact with the plate by the action of gravity or pressure, so that along the contact line between the applicator roller and the plate a tension-free coupling is obtained as if it had occurred on a plane, so as to avoid phenomena of delamination and/or of formation of air bubbles.

Furthermore, in such operative position the plate is wrapped around at least a portion of the outer cylindrical surface of the applicator roller, in order to assume an opposite curvature to that of the cylindrical support.

The present principles refer to preferred and advantageous embodiments of the invention.

### BRIEF DESCRIPTION OF THE DRAWINGS

These and further advantages will be better understood by any man skilled in the art from the following description and from the accompanying drawings, given by way of a non-limiting example, in which:

FIG. 1 is a schematic front view of a tangential flexographic plate mounting machine without tension according to the invention;

FIG. 2 is a left side view of the machine with the tangential flexographic plate mounting device without tension in its inactive position;

FIG. 3 is a right side view of the machine with the tangential flexographic plate mounting device without tension in its operative position;

FIG. 4 is a detailed front view of a tangential flexographic plate mounting device without tension according to the invention;

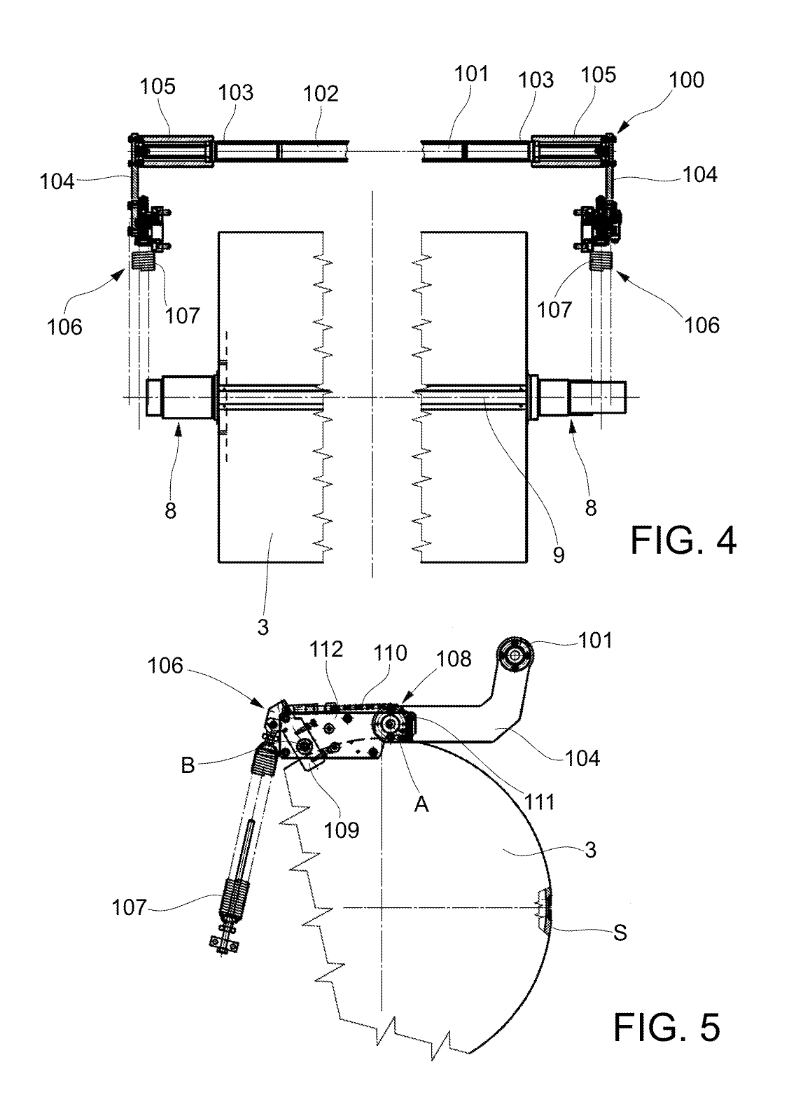

FIG. 5 is a detailed left side view of a tangential flexographic plate mounting device without tension;

FIG. 6 is a detailed right side view of a tangential flexographic plate mounting device without tension;

FIG. 7 is a left side view of construction details of the tangential flexographic plate mounting device without tension;

FIG. 8 is a right side view of further construction details of the tangential flexographic plate mounting device without tension; and

FIGS. 9-13 are schematic lateral section views of the cylindrical support associated to the applicator roller during several steps of application of the plate on the flexible support according to the invention.

### DETAILED DESCRIPTION OF THE INVENTION

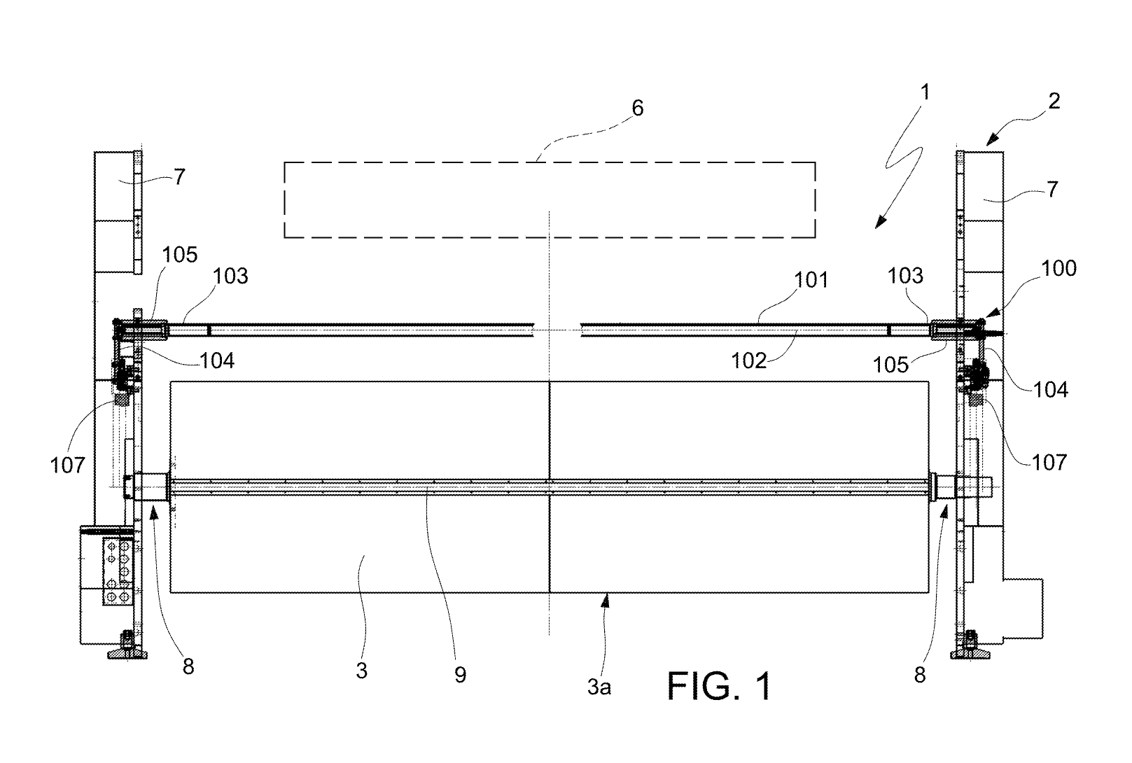

With reference to FIG. 1, reference numeral 1 globally indicates a flexographic plate mounting machine according to the present invention, incorporating a tangential flexographic plate mounting device 100 without tension that is also an object of the present invention.

Machine 1 comprises a frame 2.

Machine 1 further comprises a rigid cylindrical support 3.

The rigid cylindrical support 3 can be made, for example, of metal, of a polymeric material, or any other suitable material.

The cylindrical support 3 is rotatably coupled with frame 2.

At least one flexible support S, made of Mylar® or other equivalent material, can be applied on the outer surface 3a of the cylindrical support 3 (which is the side surface thereof in the geometric meaning).

A respective flexographic plate 5, complete with double-sided tape 4 applied on a first surface 5a thereof, can in turn be fixed on the flexible support S.

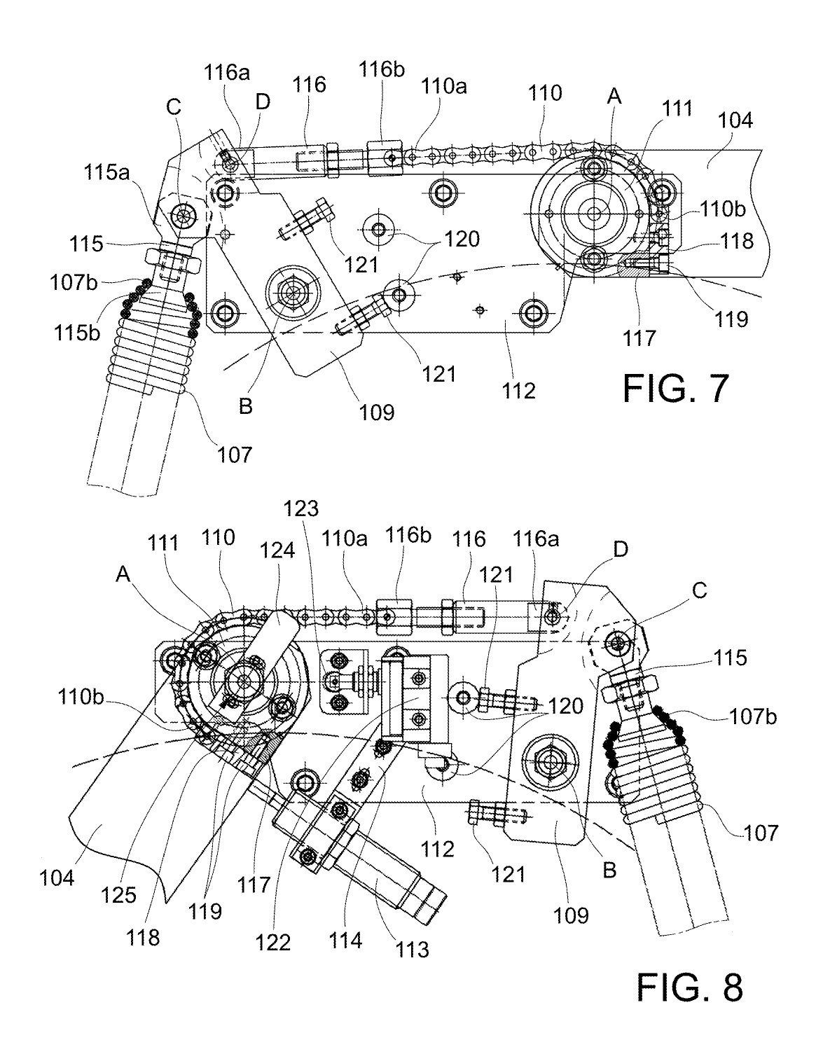

More in detail, the flexographic plate 5 comprises a first surface 5a, complete with double-sided tape 4, which can be coupled to the flexible support S, and a second printing surface 5b, opposite to the first surface 5a, i.e. wherein elements in relief are provided, suitable for transferring the ink on the surface to be printed, see in particular FIG. 6.

Machine 1 further comprises optical means 6 for checking the mounting position of plate 5 on the cylindrical support 3, i.e. on the flexible support S.

Machine 1 in particular comprises a device 100 for mounting the flexographic plate 5, complete with double-sided tape 4, on the flexible support S. Frame 2 of machine 1 comprises two vertical facing shoulders 7.

Shoulders 7 are connected by at least one upper cross member, not shown in the figures for simplicity.

Shoulders 7 comprise respective rotatable support means for a shaft 9 with horizontal axis, on which the cylindrical support 3 is mounted.

Shaft 9 may be possibly associated to driving means, such as a geared motor or the like—not shown in the figures—adapted to set it rotating about its own axis during the mounting of plate 5 on the cylindrical support 3.

The optical means 6, schematically shown with broken line in FIG. 1, may be of any type suitable to allow the operator to check the correct positioning of the flexographic plate 5 on the flexible support S, in relation to specific position references.

For example, the optical means 6 may include mirrors and/or cameras and/or any other component suitable to carry out the above check.

The optical means 6 are operatively connected to a unit for managing the operation of the machine, not shown for simplicity in the figures, for example comprising a user interface.

The tangential flexographic plates mounting device 100 without tension incorporated in machine 1 comprises, according to one aspect of the present invention, an applicator roller 101 of the flexographic plate 5, complete with double-sided tape 4, on the flexible support S.

The applicator roller 101 has the respective axis of symmetry 102 parallel to that of the cylindrical support 3.

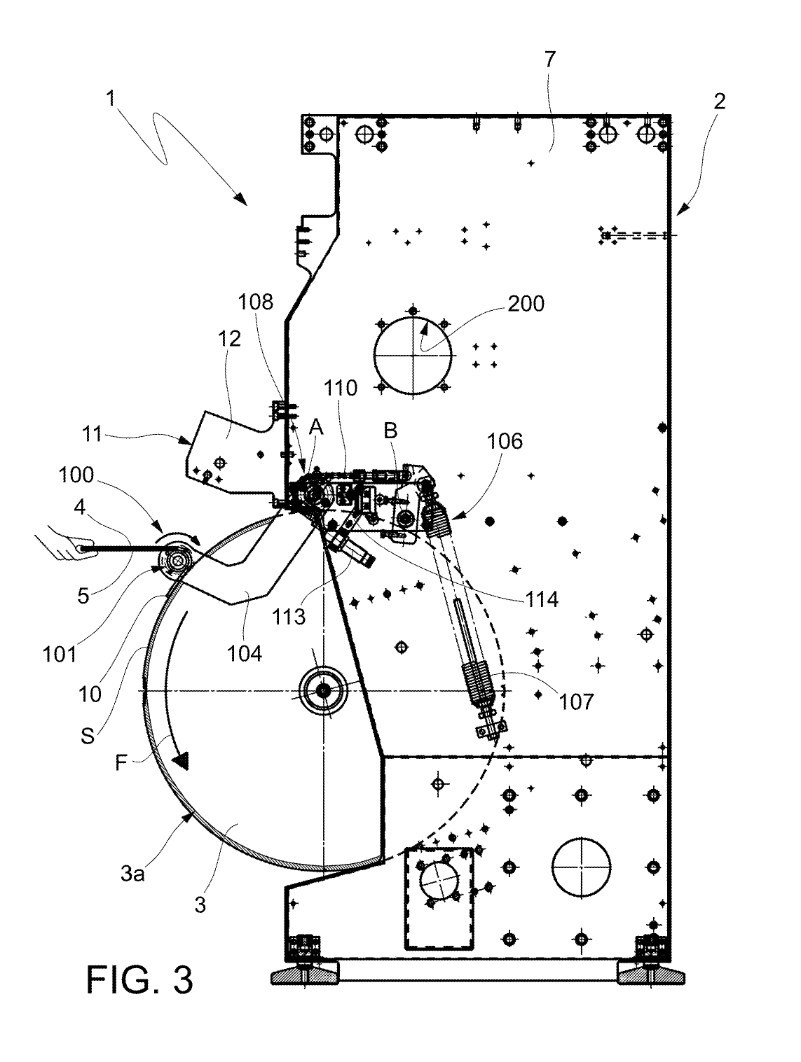

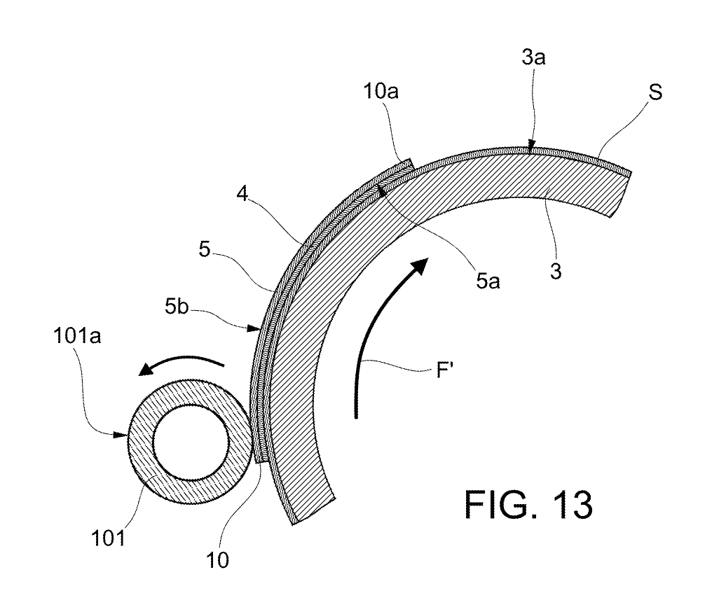

According to another aspect of the present invention, the applicator roller 101 is movable between an inactive position and an operative application position of plate 5, complete with double-sided tape 4, on the flexible support S starting from an end edge 10 thereof (FIGS. 3,6) or from the middle portion M thereof, (FIGS. 9-13).

In said operative position, the applicator roller 101 is in rolling contact with the printing surface 5b of the plate 5, with the technical effects that will become clearer hereinafter.

According to a further aspect of the present invention, the applicator roller 101 is rotatably supported at the respective ends 103 by two respective arms 104 articulated to frame 2 of machine 1.

More in detail, arms 104 are articulated to frame 2 in a first articulation axis A, substantially provided above the cylindrical support 3.

In this way, said rolling contact between the applicator roller 101 and the flexible support S is obtained and maintained simply by gravity.

Therefore, according to an aspect of the invention, along the contact line, or along the contact surface, between the applicator roller 101 and the plate 5 a tension-free coupling is obtained as if it had occurred on a plane, so as to avoid phenomena of delamination and/or formation of air bubbles.

According to an aspect of the invention, in the operative position of the applicator roller 101 the plate 5 is wrapped around at least a portion of the outer cylindrical surface 101a of the applicator roller 101, in order to assume an opposite curvature to that of the cylindrical support 3.

The applicator roller 101 is made of a rigid or substantially rigid material, such as metal or a polymeric material.

Each arm 104 integrally carries a respective bushing 105, within which the corresponding end 103 of the applicator roller 101 is rotatably supported on bearings.

Each arm 104 is substantially “L”-shaped.

Each arm 104 includes a first free end 104a and a second free end 104b.

In particular, the first articulation axis A is provided at the first free end 104a.

The applicator roller 101 is instead rotatably supported at the second free end 104b.

As better explained hereinafter, the “L” shape of each arm 104 allows some advantages to be obtained, among which a centre of gravity of the roller 101-arms 104 system positioned below roller 101 itself, so as to facilitate the operator in the rotation of arms 104 from the inactive position to the operative position.

Frame 2 of machine 1 comprises at least one stop surface 11 for the applicator roller 101 in said inactive position.

The stop surface 11 is provided on the front side of machine 1, i.e. where the operator normally accesses to mount plate 5, complete with double-sided, on the flexible support S.

More in detail, frame 2 of machine 1 comprises two stop surfaces 11 for the applicator roller 101.

The stop surfaces 11 are provided on respective appendages 12 integral with shoulders 7 of frame 2, at the front side of machine 1.

In particular, appendages 12 are associated to frame 2 so that the respective stop surfaces 11 are in a position easily accessible to the operator; in other words, the stop surfaces 11 are positioned on frame 2 so that the applicator roller 101 in the inactive position can be easily grasped by the operator to be moved to the operative position by gravity.

According to another aspect of the invention, the tangential flexographic plate mounting device 100 without tension comprises elastic return means, globally indicated with reference numeral 106, associated with the applicator roller 101.

The elastic return means 106 are connected to frame 2 of machine 1; in particular, the elastic return means 106 are associated with at least one of shoulders 7 of frame 2.

The elastic return means 106 are adapted to hold the applicator roller 101 in said inactive position.

In other words, the elastic return means 106 hold the applicator roller 101, when not in use, in such a position as not to interfere with any other interventions that the operator must perform on machine 1, or with other operating conditions of machine 1 itself.

As said, the elastic return means 106 may be associated with only one of shoulders 7 of frame 2 or with only one end 103 of the applicator roller 101.

In the embodiment of the invention shown, however, each shoulder 7 of frame 2 is associated with respective elastic return means 106 of the applicator roller 101.

More in detail, the elastic return means 106 comprise at least one cylindrical coil spring 107 for each shoulder 7 of frame 2.

Spring 107 comprises a first end 107a and a second end 107b opposite each other.

The first end 107a of spring 107 is fixed to frame 2 of machine 1.

In particular, the first end 107a is fixed to the respective shoulder 7 of frame 2.

The second end 107b of spring 107 is instead associated with a transformation mechanism, globally indicated with reference numeral 108, of the return force of spring 107 into a return torque of the respective arm 104 about the first articulation axis A.

Said transformation mechanism 108 comprises a rocker arm 109.

The rocker arm 109 is articulated to frame 2—that is, to the respective shoulder 7—in a second articulation axis B.

The rocker arm 109 is further articulated to the second end 107b of spring 107 in a third articulation axis C.

Finally, the rocker arm 109 is articulated to a chain 110, in particular to a first end portion 110a thereof, at a fourth articulation axis D.

Chain 110 engages with a respective pinion 111 integral with the respective arm 104; in particular, pinion 111 has its axis coinciding with the first articulation axis A.

A simple wheel may also be provided in place of pinion 111.

Chain 110 comprises a second end portion 110b fixed to the peripheral portion of pinion 111.

The tangential flexographic plate mounting device 100 without tension comprises a support plate 112 associated with the respective shoulder 7 of frame 2.

The first articulation axis A and the second articulation axis B are provided in plate 112.

More in detail, seats are provided in plate 112 for mounting respective rolling bearings that define said first axis A and second axis B.

In the embodiment shown, the elastic return means 106 further comprise one damper 113 adapted to stop the motion of at least one of arms 104 in passing from the inactive position to the operative position, thus preventing the applicator roller 101 from hitting the surface of the cylindrical support 3 in an uncontrolled manner.

More in detail, damper 113 is supported by a respective bracket 114 fixed to the support plate 112.

Damper 113 may consist, for example, of a gas spring or other equivalent component.

It is noted that in any case, the presence of damper 113 is completely optional.

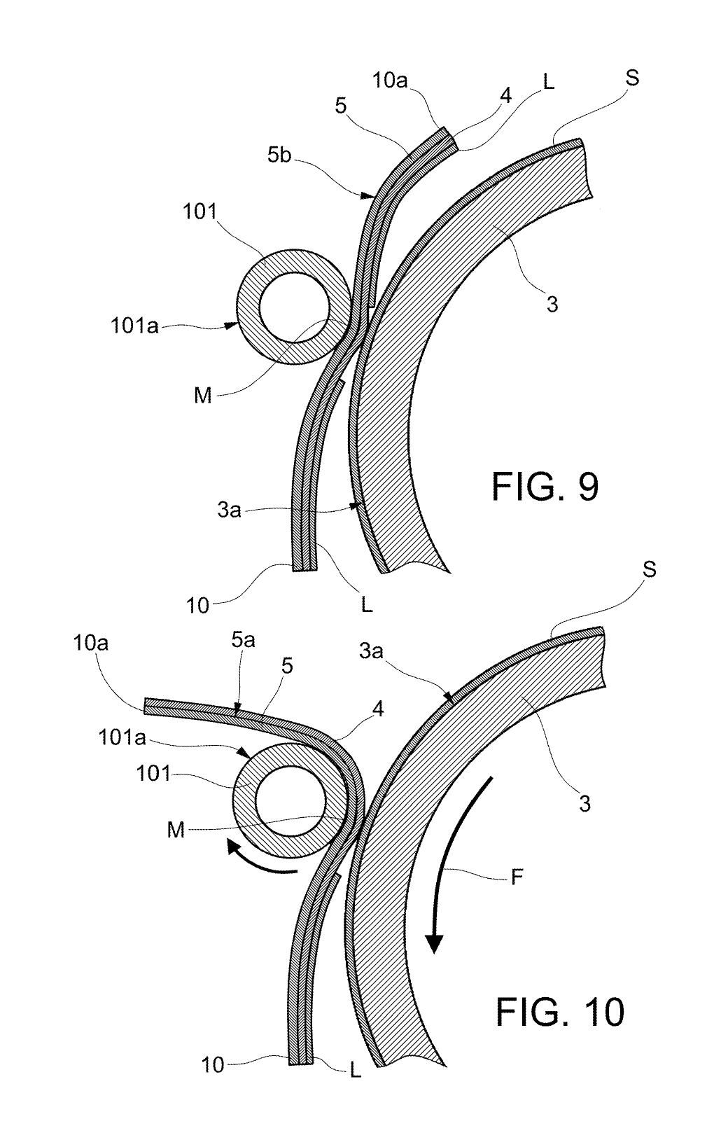

Further construction details of the solution object of the present invention, with particular reference to elastic return means 106, are shown in FIGS. 7,8.

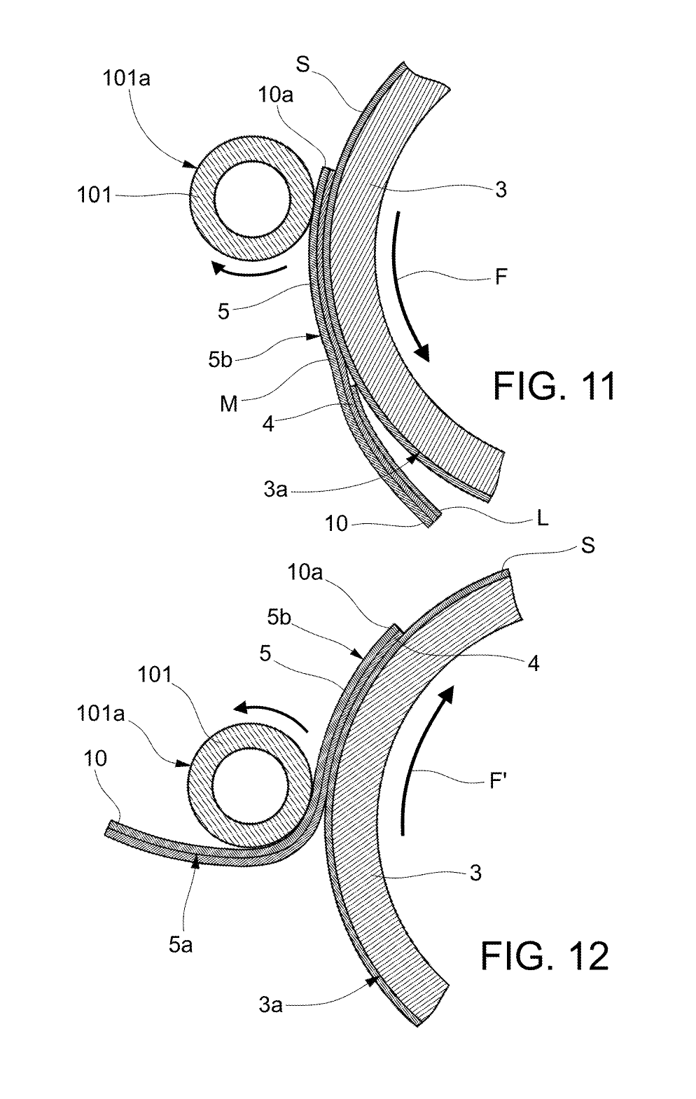

In particular, in FIG. 7 the tangential flexographic plate mounting device 100 without tension is in the inactive position while in FIG. 8 it is in the operative position.

For each shoulder 7 of frame 2, the second end 107b of the respective spring 107 is articulated to the rocker arm 109, at the third articulation axis C, by means of a head 115.

Head 115 comprises an eyelet end 115a articulated to the rocker arm 109, and a truncated-cone end 115b on which the second end 107b of spring 107, which also has a truncated-cone shape, is wound.

Head 115 can be adjusted in length through a screw connection provided between the eyelet end 115a and the truncated-cone end 115b.

The first end portion 110a of chain 110 is articulated to the rocker arm 109, at the fourth articulation axis D, via a joint 116.

Joint 116 includes an eyelet portion 116a articulated to the rocker arm 109; at the opposite end, joint 116 includes a seat 116b inside which an articulation pin of the first end portion 110a of chain 110 is inserted.

Joint 116 can be adjusted in length through a screw connection provided between the eyelet end portion 116a and seat 116b.

Pinion 111 includes, at the peripheral portion thereof, a flattened portion 117.

In particular, the flattened portion 117 defines a surface which develops according to a plane tangent to the peripheral portion of pinion 111.

The second end portion 110b of chain 110 is connected to the flattened portion 117 via a block 118 fixed by screws 119.

The support plate 112 includes limit switch elements 120 for the respective rocker arm 109 in the two angular end positions thereof.

The limit switch elements 120 are urged in respective holes provided in the support plate 112, at suitable positions.

Respective screw heads 121 urged in a same side of the rocker arm 109 abut on the limit switch elements 120.

The two limit switch positions of the rocker arm 109 are shown in FIGS. 7 and 8, respectively.

The plate mounting machine 1 according to the invention may be of the type also suitable to carry out printing tests after mounting plate 5 complete with double-sided tape 4, on the flexible support S.

In this case, a counter-pressure cylinder rotatably supported in frame 2, for example at hole 200 and in rolling contact with the cylindrical support 3, and an inking device for distributing the printing ink on the surface of plate 5, may be mounted on machine 1.

The counter-pressure cylinder and the inking device are not shown in the figures.

If machine 1 is equipped in this way, a safety switch 122 operatively connected to said inking device may be installed on at least one of the support plates 112 provided on sides 7 of frame 2.

In particular, the safety switch 122 is adapted to enable the actuation of the inking device when the tangential flexographic plate mounting device 100 without tension is in its inactive position.

In this way, the applicator roller 101 is prevented from interfering with the operation of application of the ink on the surface of plate 5.

The safety switch 122 for example consists of a so-called micro-switch, fixed to the respective plate 112 and having a button 123 facing pinion 111 of the respective elastic return means 106.

A finger 124 for actuating button 123 is fixed to pinion 111.

In particular, finger 124 can be fixed in an adjustable manner to pinion 111 via screws inserted through slots 125. As can be appreciated by looking at FIG. 8, when the tangential flexographic plate mounting device 100 without tension is in the operative position, i.e., when the applicator roller 101 is in rolling contact with the flexible support S, finger 124 is far from button 123 of switch 122.

In this condition, the inking device is not enabled to be operated.

Conversely, when the tangential flexographic plate mounting device 100 without tension is moved to the respective inactive position, finger 124 comes into contact with button 123, thus actuating switch 122.

Such an actuation enables the start of the device for inking the surface of plate 5.

The operation of the tangential flexographic plate mounting device 100 without tension and of the plate mounting machine 1 incorporating it therefore is as follows.

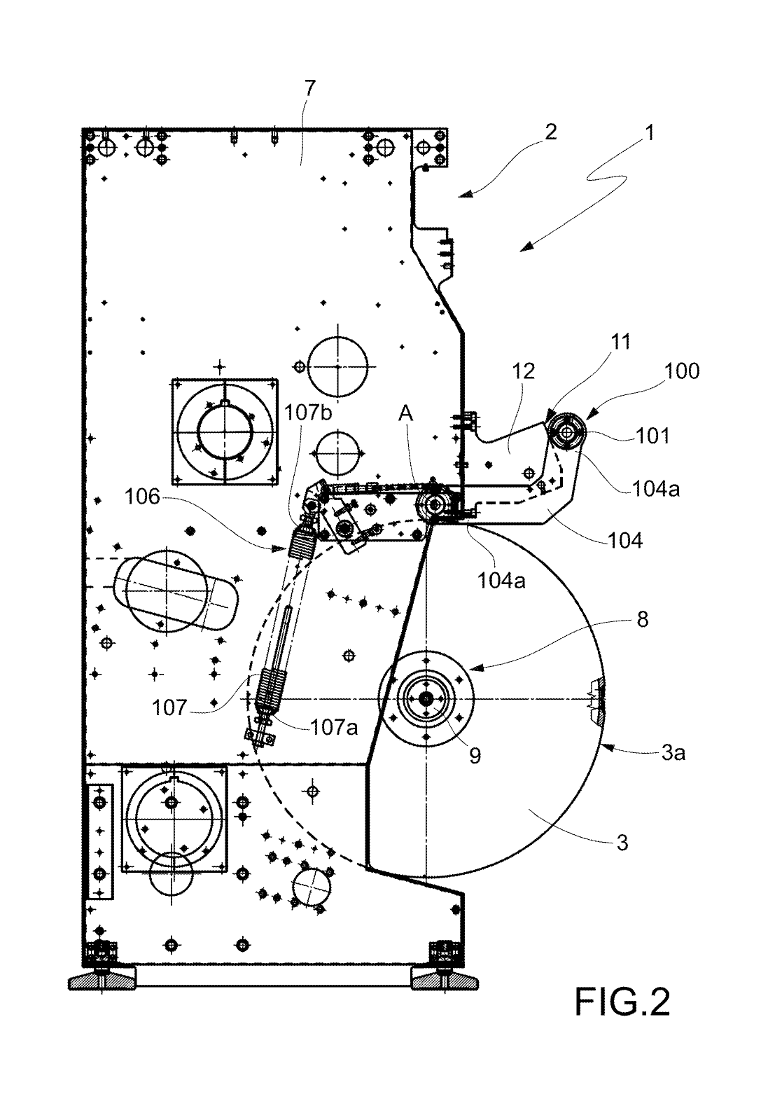

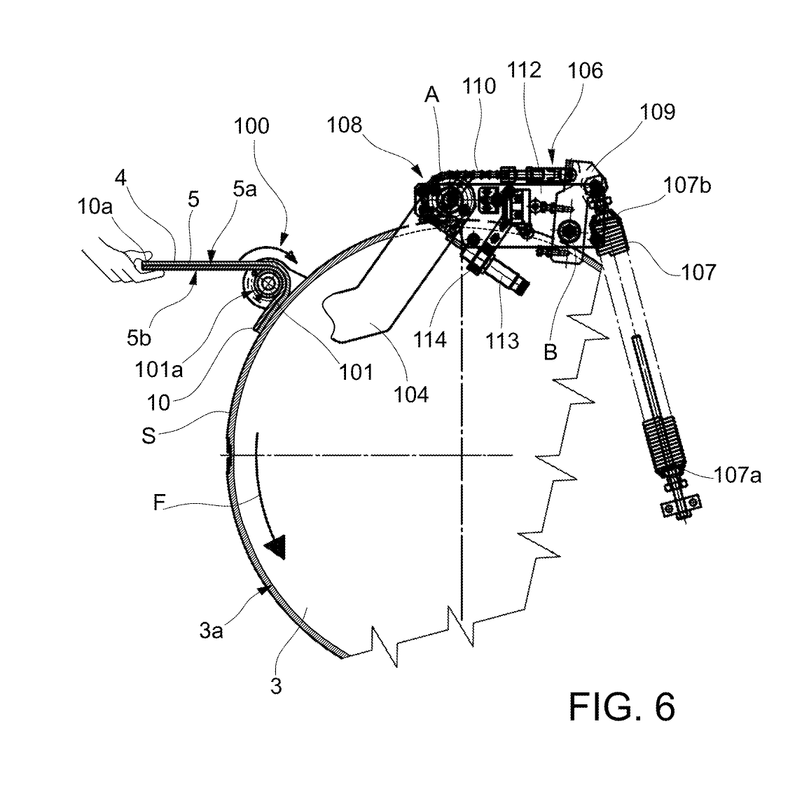

Initially, the applicator roller 101 is located, as shown in FIG. 2 and in the detail in FIG. 5, in its inactive position, stably held by the elastic return mechanism 106.

In this position, the applicator roller 101 is raised relative to the surface of the cylindrical support 3, at such a height as not to disturb the operator.

A flexible support S is applied on the surface of the cylindrical support 3, so as to adhere to its outer surface 3a.

The plate 5 can be coupled to the flexible support S starting from an edge 10,10a thereof, or from the middle portion M thereof.

Starting from the middle portion M can be advantageous for the wider plates 5, for the reasons better explained hereafter.

According to a first application situation (FIGS. 3,6), the plate 5 can be coupled to the flexible support S starting from an edge 10,10a thereof: this situation could be convenient for the smaller plates 5.

The plate 5, complete with double-sided tape 4 on its first surface 5a, could be eventually initially associated with a protective liner which covers, at least partially, the adhesive surface of the double-sided tape 4.

In particular, the lower edge 10 of the plate 5 is applied on the flexible support S, using for example reference signs provided thereof.

The lower edge 10 is the one that is located below when viewed from the operator facing the machine 1.

Therefore, the lower edge 10 of the plate 5 initially adheres to the flexible support S.

Hence, the applicator roller 101 is lowered manually until it reaches its operative position, in which it is in rolling contact with the first surface 5a of the plate 5, by the lower edge 10 thereof (see for example FIG. 6).

At this point, the cylindrical support 3 is actuated to rotate—manually or automatically—about the axis of shaft 9, in a first direction, indicated by arrow F in FIG. 6.

The rotation of the cylindrical support 3, due to the first adhesion obtained between the lower edge 10 of the printing plate 5, complete with double-sided tape 4, and the flexible support S, pulls plate 5 itself, while it is manually held by the operator by the opposite upper edge 10a.

More in detail, the operator, facing the machine 1, exerts a certain manual pulling action on the upper edge 10a of the plate 5, during rotation of the cylindrical support 3.

In this way, during mounting the plate 5 is wrapped around at least a portion of the outer cylindrical surface 101a of the applicator roller 101.

In particular, during application of the plate 5 on the flexible support S the plate 5 is wrapped around the outer cylindrical surface 101a of the applicator roller 101 with a wrapping angle which is comprised between 150° and 210°: in a preferred embodiment of the invention, such wrapping angle is about 180°.

Therefore, according to the invention, during mounting the plate 5 assumes a curvature which is opposite to that of the cylindrical support 3.

This allows to mutually cancel the mounting tensions in the two components (plate 5 and flexible support S).

By wrapping around the applicator roller 101, plate 5 progressively adheres to the flexible support S, up to the complete coupling.

Due to the rolling contact between the plate 5 and the applicator roller 101, in particular ensured by the weight of roller 101 itself and of the related arms 104, a perfect adhesion of plate 5 on the surface of the flexible support S is obtained without air bubbles being trapped between the two components.

In fact, due to the tangential flexographic plate mounting device 100 without tension according to the invention, plate 5 is suitably stretched and pulled (with a curvature opposite to that of the cylindrical support 3) directly in the application step on the flexible support S, rather than after the application as it happens in plate mounting machines of a known type, without creating high tension areas which are precisely those below which air bubbles are formed when using machines of a known type.

A result is thus obtained which is similar to what occurs in machines in which plate 5, complete with double-sided tape 4 is mounted flat on the flexible support S, for example in the particular case of plates for printing on corrugated cardboard.

As the flexible support S, together with the plate 5, is removed from the cylindrical support 3, it appears to be perfectly flat and it doesn't retain any residual curvature due to mounting tensions.

The need to exert a pressure on the surface of plate 5, after the application of plate 5 itself (complete with double-sided tape 4) on the flexible support S to expel any air bubbles is therefore completely eliminated.

The corresponding pressure means can therefore be eliminated and the plate mounting machine 1 therefore becomes simpler and more cost-effective.

The result obtained is particularly important in the case of thick flexographic plates 5, or comprising substantial portions of relief and low relief surface, for which the pressure means of the machines of the known type can be, as said, ineffective.

Another important advantage obtained with the solution according to the present invention is the possibility of using less expensive double-sided tape 4, since the optimum adhesion between the components is obtained directly in the application step: at that point, the detachment phenomena are extremely less probable.

It is noted that the tangential flexographic plate mounting device 100 without tension according to the present invention can be easily installed as a retrofit kit on existing and already operational plate mounting machines 1.

In fact, the installation only requires for providing the fixing holes for the support blocks 112, appendages 12 and the first ends 107a of springs 107.

The new machines 1 can of course be already constructed with said holes to install the tangential flexographic plate mounting device 100 without tension only on request.

The tangential flexographic plate mounting device 100 without tension is constructively very simple and includes components that are quick and cost-effective to make, in addition to components already available on the market.

In the case of mounting of particularly large or thick plates 5, the applicator roller 101 may be provided with means suitable for increasing the pressure that it exerts on the surface of the cylindrical support 3, and thus on the surface of plate 5 during its application.

For example, such means may comprise simple masses applied to arms 104, or actuators—such as pneumatic or electro-mechanical—acting on the applicator roller 101 according to a substantially vertical downward direction.

The tangential flexographic plate mounting device 100 without tension prevents delamination (detachment) and the formation of air bubbles between plate 5 and the flexible support S, since a coupling without residual mounting tension is obtained on the contact line, or contact surface, between the applicator roller 101 and the plate 5 as if it was on a plane.

The latter effects are also fully obtained with large and/or thick plates 5 (even up to about 7-8 mm) and with the use of any type of double-sided tapes, even inexpensive.

In addition, it is noted that the application roller 101 greatly facilitates the operator in supporting and moving large plates 5.

In case of a partial or full automation of the machine 1 or of the mounting device 100 according to the invention, pulling means can be foreseen for exerting a certain pulling action on the upper edge 10a of the plate, in order to achieve an effective winding of the plate 5 around the applicator roller 101 during mounting operations.

According to a second application situation (FIGS. 9-13), the plate 5 can be coupled to the flexible support S starting from a middle portion M thereof.

This situation could be convenient for the wider plates 5: in fact, in wider plates 5 it is easier to expel air bubbles starting from a middle portion M rather than an edge portion of the plate 5.

Furthermore, a possible positioning error of the plate 5 onto the flexible support S has less influence (i.e. half influence) if the positioning of the plate 5 is carried out by a middle portion M thereof rather than by and edge portion thereof.

The plate 5, complete with double-sided tape 4 on its first surface 5a, could be eventually initially associated with a protective liner L which covers, at least partially, the adhesive surface of the double-sided tape 4.

The liner L may be absent, for example, from the middle portion M of the plate 5, in order to allow positioning on the flexible support S.

The middle portion M of the plate 5 is applied on the flexible support S, using for example reference signs provided thereof (situation shown in FIG. 9).

The applicator roller 101 is lowered manually until it reaches its operative position, in which it is in rolling contact with the middle portion M of the plate 5 (FIG. 9). The eventual protective liner L is removed from the upper portion of the plate 5.

At this point, the cylindrical support 3 is actuated to rotate—manually or automatically—about the axis of shaft 9, in the first direction indicated by arrow F in FIG. 6.

The rotation of the cylindrical support 3, due to the first adhesion obtained between the middle portion M of the printing plate 5, complete with double-sided tape 4, and the flexible support S, pulls plate 5 itself, while it is manually held by the operator by the opposite upper edge 10a (FIG. 10).

The operator, facing the machine 1, exerts a certain manual pulling action on the upper edge 10a of the plate 5, during rotation of the cylindrical support 3.

In this way, during mounting the plate 5 is wrapped around at least a portion of the outer cylindrical surface 101a of the applicator roller 101.

In particular, during application of the plate 5 on the flexible support S the upper portion of the plate 5 is wrapped around the outer cylindrical surface 101a of the applicator roller 101 with a wrapping angle which is comprised between 150° and 210°: in a preferred embodiment of the invention, such wrapping angle is about 180°.

Therefore, according to the invention, during mounting the upper portion of plate 5 assumes a curvature which is opposite to that of the cylindrical support 3.

This allows to mutually cancel the mounting tensions in the two components (plate 5 and flexible support S).

By wrapping around the applicator roller 101, the upper portion of plate 5 progressively adheres to the flexible support S, up to the complete coupling (FIG. 11).

The cylindrical support 3 is now actuated to rotate—manually or automatically—about the axis of shaft 9, in a second direction, indicated by arrow F′ in FIG. 12, which is opposite to first direction F.

As a result of this rotation, the applicator roller 101 reaches again the middle portion M of the plate 5 (FIG. 12).

The eventual protective liner L is removed from the lower portion of the plate 5.

The cylindrical support 3 is therefore actuated to further rotate, about the axis of shaft 9, again in the second direction indicated by arrow F′.

The operator, facing the machine 1, holds the lower edge 10 of the plate 5 and exerts a certain manual pulling action on it, during rotation of the cylindrical support 3.

In this way, during mounting the plate 5 is wrapped around at least a portion of the outer cylindrical surface 101a of the applicator roller 101.

In particular, during application of the plate 5 on the flexible support S the lower portion of the plate 5 is wrapped around the outer cylindrical surface 101a of the applicator roller 101 with a wrapping angle which is comprised between 150° and 210°: in a preferred embodiment of the invention, such wrapping angle is about 180°.

Therefore, according to the invention, during mounting the lower portion of the plate 5 assumes a curvature which is opposite to that of the cylindrical support 3.

This allows to mutually cancel the mounting tensions in the two components (plate 5 and flexible support S).

By wrapping around the applicator roller 101, the lower portion of plate 5 progressively adheres to the flexible support S, up to the complete coupling (FIG. 13), exactly as has happened the upper portion of the plate 5.

An object of the present invention is also a method for fixing a flexographic plate 5 on a flexible support S comprising, as described above, the steps of providing a rigid cylindrical support 3 rotatably coupled with a frame 2 and applying at least a flexible support S on the outer surface 3a of the cylindrical support 3.

Moreover, the method includes the steps of providing an applicator roller 101 of plate 5 on the flexible support S; such a roller 101 is movable between an inactive position and an operative application position of plate 5 on the flexible support S starting from an end edge 10 thereof or from a middle portion M thereof.

The method therefore provides for a step of moving the applicator roller 101 to said operative position in which the applicator roller 101 itself is placed in rolling contact with the plate 5 by gravity, by the lower edge 10 thereof or by the middle portion M thereof.

The method then comprises a step of setting the cylindrical support 3 in rotation, either manually or automatically, so as to pull plate 5, complete with double-sided tape 4, in adhesion on the flexible support S.

The method also comprises a step of exerting, during rotation of the cylindrical support 3, a certain pulling action on the upper edge 10a, or on the lower edge 10, of the plate 5 in order to wrap the plate 5 itself around at least a portion of the outer cylindrical surface 101a of the applicator roller 101, so that the plate 5 assumes a curvature which is opposite to that of the cylindrical support 3.

In particular, during application of the plate 5 on the flexible support S, the plate 5 is wrapped around the outer cylindrical surface 101a of the applicator roller 101 with a wrapping angle which is comprised between 150° and 210°: in a preferred embodiment of the invention, such wrapping angle is about 180°.

This allows mutual cancelling of the mounting tensions on the plate 5 and on the flexible support S, achieving a coupling which is totally free of residual tensions which could cause the formation of air bubbles or detachments between the components.

It has thus been seen that the invention achieves the intended objects.

The present invention has been described according to preferred embodiments but equivalent versions may be conceived without departing from the scope of protection offered by the following claims.

1. A tangential flexographic plate mounting device without tension on a flexible support, comprising:
a frame and a rigid cylindrical support rotatably coupled with said frame;
said cylindrical support comprising an outer surface on which it is possible to apply at least a flexible support, on which in turn a flexographic plate, complete with double-sided tape, is fixable;
said device further comprising at least one applicator roller of said plate, complete with double-sided tape, on the flexible support, having axis of symmetry parallel to that of said cylindrical support and being mobile between an inactive position and an operative application position of said plate complete with double-sided tape on said flexible support from an end edge thereof or from the middle portion thereof;
in said operative position said applicator roller being kept in rolling contact with the plate by the action of gravity or pressure, so that along the contact surface between said applicator roller and the plate a tension-free coupling is obtained as if it had occurred on a plane, so as to avoid phenomena of delamination and/or of formation of air bubbles; and
in said operative position and during application the plate being wrapped around at least a portion of the outer cylindrical surface of said application roller, in order to assume, during application, an opposite curvature to that of said cylindrical support.

2. The device according to claim 1, wherein said applicator roller is rotatably supported at the respective ends by two respective arms articulated to said frame in a first articulation axis foreseen substantially above said cylindrical support.

3. The device according to claim 2, comprising elastic return means associated with said applicator roller and connected to said frame, said elastic return means being suitable for holding said applicator roller stably in said inactive position.

4. The device according to claim 3, wherein said elastic return means comprise at least one cylindrical coil spring having a first end fixed to said frame, and a second end associated with a transformation mechanism of the return force of said spring into a return torque of at least one of said arms about said first articulation axis.

5. The device according to claim 4, wherein said transformation mechanism comprises a rocker arm articulated to said frame in a second articulation axis, said rocker arm also being articulated to said second end of said spring in a third articulation axis and, at a fourth articulation axis, to the first end portion of a chain, said chain being engaged with a pinion or a wheel fixedly connected to said arm at said first articulation axis and having the second end portion fixed to the peripheral portion of said pinion or wheel.

6. The device according to claim 2, wherein each of said arms is substantially L-shaped, said first articulation axis being foreseen at a first free end of said arm, said applicator roller being rotatably supported at the second free end of said arm.

7. The device according to claim 1, wherein said frame comprises at least one stop surface for said applicator roller in said inactive position.

8. The device according to claim 2, comprising at least one damper suitable for stopping the motion of at least one of said arms in passing from said inactive position to said operative position.

9. The device according to claim 1, wherein during application onto the flexible support, said plate is wrapped around said outer cylindrical portion of said application roller with a wrapping angle which is comprised between 150° and 210°.

10. A tangential flexographic plate mounting machine without tension, comprising
a frame;
a cylindrical support, rotatably coupled with said frame, on which it is possible to apply at least a flexible support on which it is in turn possible to fix a respective flexographic plate already complete with double-sided tape, optical means for verifying the mounting position of said plate on said cylindrical support; and
a tangential flexographic plate mounting device without tension according to claim 1.

11. A method for fixing a flexographic plate on a flexible support, comprising the steps of:
providing a cylindrical support having an outer surface, rotatably coupled with a frame;
providing at least a flexible support;
applying said flexible support onto said outer surface of said cylindrical support;
applying said plate on said flexible support starting from an end edge thereof or from the middle portion thereof;
providing an applicator roller of said plate, complete with double-sided tape, on said flexible support, moveable between an inactive position and an operative application position of said plate, complete with double-sided tape, on said flexible support;
taking said applicator roller into said operative position in which said applicator roller is placed in rolling contact with said plate by gravity or pressure, by and end edge thereof or by the middle portion thereof;
setting said cylindrical support in rotation so as to pull said plate, complete with double-sided tape, in adhesion on said flexible support, so that along the contact surface between said applicator roller and said plate a tension-free coupling is obtained as if it had taken place on a plane, so as to avoid phenomena of delamination and/or of formation of air bubbles; and
in said operative position and during application the plate being wrapped around at least a portion of the outer cylindrical surface of said applicator roller, in order to assume, during application, a curvature which is opposite to that of said cylindrical support.

12. The method according to claim 11, wherein said step of setting said cylindrical support in rotation comprises a step of exerting a certain pulling action on said edge of said plate, in order to keep said plate at least partially wounded around the outer cylindrical surface of said applicator roller.

13. The method according to claim 12, wherein said step of exerting a certain pulling action on said edge of said plate is performed manually or automatically by pulling means.

14. The method according to claim 11, wherein, in case said step of applying said plate on said flexible support is performed by starting from the middle portion thereof, said step of setting said cylindrical support in rotation is performed in a first rotation direction in order to make the upper or lower portion of said plate adhere onto said flexible support, and subsequently in a second rotation direction opposite to said first rotation direction in order to make the remaining and opposite portion of said plate adhere onto said flexible support.

15. The method according to claim 11, wherein during application onto the flexible support, said plate is wrapped around said outer cylindrical surface of said application roller with a wrapping angle which is comprised between 150° and 210°.
